(19) United States
(12) Patent Application Publication
(10) Pub. No.: US 2026/0316601 A1
(43) Pub. Date: Oct. 15, 2026

(54) ELECTRIC APPARATUS

(71) Applicant: HONDA MOTOR CO., LTD., Tokyo (JP)

(72) Inventors: Keiya Nimura, Tokyo (JP); Yoshihisa Kubota, Tokyo (JP); Somei Nakatomi, Tokyo (JP)

(21) Appl. No.: 19/467,894

(22) Filed: Feb. 3, 2026

(30) Foreign Application Priority Data
Mar. 28, 2025 (JP) 2025-055464

(51) Int. Cl. B60L 53/10; B60L 53/24; H02M 3/335; H02M 7/219

(52) U.S. Cl. CPC B60L 53/11; B60L 53/24; H02M 3/33573; H02M 3/33592; H02M 7/219; B60L 2210/10; B60L 2210/30

(57) ABSTRACT

An electric apparatus includes: an electric power control unit controlling electric power transfer of an electric power storage device and a rotary electric machine; a DC charging terminal connecting the electric power control unit to an external DC electric power source; and a position sensor detecting a rotor angle of the rotary electric machine. The electric power control unit includes a first full-bridge circuit connected to both ends of a first coil, a second full-bridge circuit connected to both ends of a second coil, and a controller controlling the first full-bridge circuit based on a duty command value and a first carrier wave and controlling the second full-bridge circuit based on the duty command value and a second carrier wave. The controller sets a phase difference between the first and second carrier waves based on the rotor angle obtained from an output signal of the position sensor during DC charging.

### CROSS-REFERENCE TO RELATED APPLICATION

Priority is claimed on Japanese Patent Application No. 2025-055464, filed on Mar. 28, 2025, the contents of which are incorporated herein by reference.

### BACKGROUND

### Field of the Invention

The present invention relates to an electric apparatus.

### BACKGROUND

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, an electric vehicle is known which converts AC electric power supplied from an external electric power source into DC electric power by a combination of stator windings of a plurality of phases of a motor and bridge circuits of a plurality of phases by switching elements (for example, refer to Japanese Unexamined Patent Application, First Publication No. 2012-70613). In this electric vehicle, by a current from the external electric power source being supplied to a connection point that divides the stator winding of each phase into two, magnetic fluxes in a magnetic circuit of the motor cancel each other, and generation of a torque is prevented.

### SUMMARY

In the technique relating to charging and electric power supply in a mobility on which a secondary battery is mounted, a problem to be solved is to improve the charging efficiency of DC charging by the external electric power source, but in the related art described above, there is room for improvement from the viewpoint of improving the charging efficiency of DC charging.

The present application aims at achieving an improvement of the charging efficiency at the time of DC charging. Further, the present application contributes to energy efficiency.

An electric apparatus according to a first aspect of the present invention includes: an electric power storage device; a rotary electric machine; an electric power control unit that is connected to the electric power storage device and the rotary electric machine and controls electric power transfer of each of the electric power storage device and the rotary electric machine; a DC charging terminal that connects the electric power control unit to an external DC electric power source; and a position sensor that detects a rotation angle of a rotor of the rotary electric machine as a rotor angle, wherein the rotary electric machine includes a first coil and a second coil that have a phase which is orthogonal to each other, the electric power control unit includes a first full-bridge circuit connected to both ends of the first coil, a second full-bridge circuit connected to both ends of the second coil, and a control device that controls the first full-bridge circuit based on a duty command value and a first carrier wave and controls the second full-bridge circuit based on the duty command value and a second carrier wave, and the control device sets a phase difference between the first carrier wave and the second carrier wave based on the rotor angle obtained from an output signal of the position sensor at a time of DC charging in which the electric power storage device is charged by electric power supplied from the external DC electric power source.

A second aspect is the electric apparatus according to the first aspect described above, wherein the first coil may be constituted by connecting a third coil and a fourth coil in series in a state where the third coil and the fourth coil are coupled in an identical direction, the second coil may be constituted by connecting a fifth coil and a sixth coil in series in a state where the fifth coil and the sixth coil are coupled in an identical direction, a positive electrode of the DC charging terminal may be connected to each of a connection point between the third coil and the fourth coil and a connection point between the fifth coil and the sixth coil, and a negative electrode of the DC charging terminal may be connected to a negative electrode of the electric power storage device.

A third aspect is the electric apparatus according to the first aspect described above, wherein at the time of DC charging, the control device may control the first full-bridge circuit and the second full-bridge circuit such that each of the first full-bridge circuit and the second full-bridge circuit operates as an interleaved boost converter.

A fourth aspect is the electric apparatus according to any one of the first to third aspects described above, wherein the first coil may be constituted of the third coil and the fourth coil in which a middle point of the first coil is a boundary, and the third coil and the fourth coil may be wound around an identical slot in the rotary electric machine.

A fifth aspect is the electric apparatus according to the fourth aspect described above, wherein the second coil may be constituted of the fifth coil and the sixth coil in which a middle point of the second coil is a boundary, the fifth coil and the sixth coil may be wound around a different slot of an identical phase in the rotary electric machine, and when controlling the first full-bridge circuit and the second full-bridge circuit such that electric power is supplied to the second coil among the first coil and the second coil at the time of DC charging, the control device may control the first full-bridge circuit and the second full-bridge circuit such that a current flows in a direction in which a magnetic field is cancelled with respect to the rotor.

According to the first aspect, the phase difference between the first carrier wave and the second carrier wave is set based on the rotor angle at the time of DC charging, and thereby, it is possible to prevent a magnetic flux density of each phase from being increased. As a result, an iron loss is reduced, and the charging efficiency is improved.

According to the second aspect, since an iron loss is reduced by a current flowing in a direction in which each of the first coil and the second coil cancels a magnetic flux, the charging efficiency is improved, and it is possible to prevent a charging torque from being generated.

According to the third aspect, since the ripple of the current that flows through each coil is reduced, the effect of reducing the iron loss and the effect of improving the charging efficiency are further enhanced.

According to the fourth aspect, by employing a structure in which the third coil and the fourth coil are wound around the identical slot in the rotary electric machine, a magnetic coupling degree between the third coil and the fourth coil can be enhanced, and therefore, it is possible to improve the charging efficiency.

According to the fifth aspect, it is possible to prevent a charging torque from being generated at the rotary electric machine while structurally ensuring an inductance of the rotary electric machine.

### BRIEF DESCRIPTION OF THE DRAWINGS

FIG. 1 is a view showing a schematic configuration of an electric apparatus according to an embodiment.

FIG. 2 is a view schematically showing a configuration of a rotary electric machine of the electric apparatus according to the embodiment.

FIG. 3 is a view showing states of a first carrier wave, a second carrier wave, and each element portion at the time of DC charging.

FIG. 4 is a view showing the case where an arbitrary phase difference between the first carrier wave and the second carrier wave is present.

FIG. 5 is a view showing a correspondence relationship between a rotor angle and a carrier phase difference.

FIG. 6 is a flowchart showing a DC charging process performed by an electronic control unit of the electric apparatus according to the embodiment.

FIG. 7 is a view showing a modification example of a correspondence relationship between the rotor angle and the carrier phase difference.

FIG. 8 is a view showing the case where the phase difference between the first carrier wave and the second carrier wave is 0 degree.

FIG. 9 is a flowchart showing a modification example of a DC charging process performed by the electronic control unit of the electric apparatus according to the embodiment.

FIG. 10 is a view showing an example of a DC charging circuit included in the electric apparatus including a three-phase motor as the rotary electric machine.

FIG. 11 is a view showing changes in states of three carrier waves and each switch in the case where the electric apparatus includes the three-phase motor.

### DESCRIPTION OF EMBODIMENTS

Hereinafter, an embodiment of an electric apparatus according to the present invention will be described with reference to the drawings.

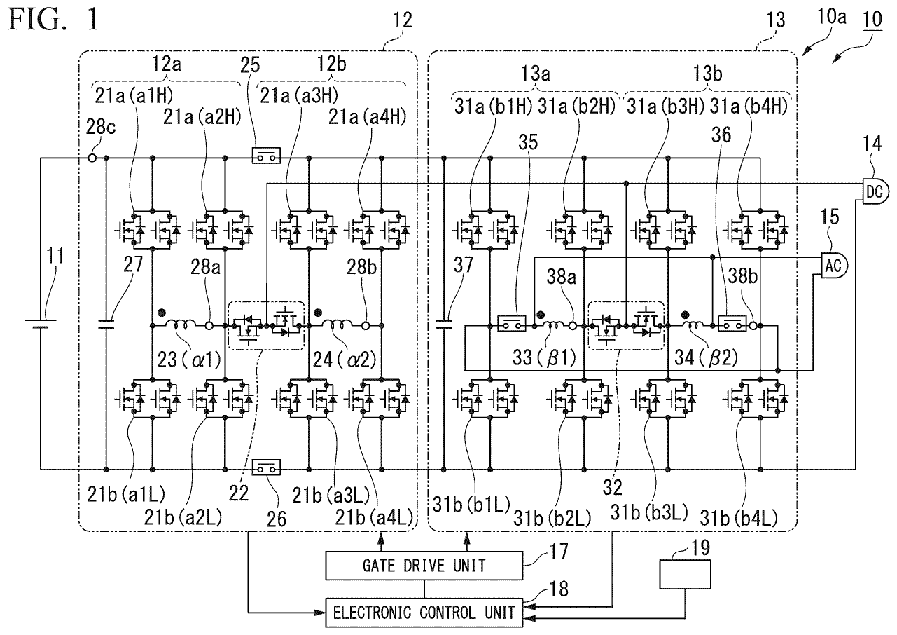

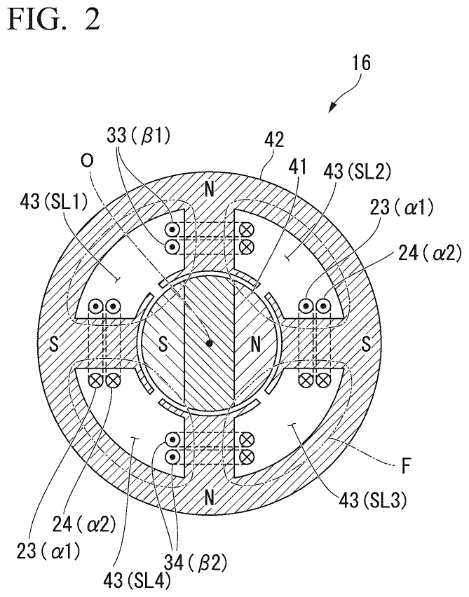

FIG. 1 is a view showing a schematic configuration of an electric apparatus 10 according to the present embodiment. FIG. 2 is a view schematically showing a configuration of a rotary electric machine 16 of the electric apparatus 10.

The electric apparatus 10 is mounted, for example, on an electric vehicle, an electric movable body, an electric machine, an electric power source device, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machine that includes a rotary electric machine as a power source and the like. The electric power source device is, for example, a stationary or mobile electric power source device that performs discharging and charging of an electric power storage device and the like.

### Electric Apparatus

As shown in FIG. 1 and FIG. 2, the electric apparatus 10 includes, for example, an electric power storage device 11, a first electric power conversion portion 12 (first full-bridge circuit), a second electric power conversion portion 13 (second full-bridge circuit), a DC charging terminal 14, an AC charging terminal 15, a rotary electric machine 16, a gate drive unit 17, an electronic control unit 18 (control device), and a position sensor 19. For example, the first electric power conversion portion 12, the second electric power conversion portion 13, the DC charging terminal 14, the AC charging terminal 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging.

The electric power storage device 11 transfers electric power between the electric power storage device 11 and the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b. Each of the first full-bridge circuit 12a and the second full-bridge circuit 12b includes, for example, a so-called H-bridge circuit formed of a plurality of switching elements connected in two phases by a bridge connection. Each switching element included in the first full-bridge circuit 12a and the second full-bridge circuit 12b is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element included in the first full-bridge circuit 12a and the second full-bridge circuit 12b is, for example, an N-channel type MOSFET.

The plurality of switching elements included in the first full-bridge circuit 12a and the second full-bridge circuit 12b are, for example, a pair of transistors forming each of high-side arm and low-side arm element portions 21a, 21b that form a pair in each phase. Each pair of transistors of each element portion 21a, 21b is connected, for example, in parallel. Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 that is connected between a second middle point of the first full-bridge circuit 12a and a third middle point of the second full-bridge circuit 12b. The second middle point of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the second middle point of the first full-bridge circuit 12a is a connection point between a source of the high-side arm element portion 21a (a2H) and a drain of the low-side arm element portion 21b (a2L).

The third middle point of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the third middle point of the second full-bridge circuit 12b is a connection point between a source of the high-side arm element portion 21a (a3H) and a drain of the low-side arm element portion 21b (a3L).

The first switch 22 is, for example, a bidirectional switch formed of two switching elements. Each switching element included in the first switch 22 is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the second middle point of the first full-bridge circuit 12a and the third middle point of the second full-bridge circuit 12b by ON (conduction)/OFF (cutoff) of the two transistors.

Each transistor included in the first switch 22 may include a rectifier element such as a reflux diode which is connected in parallel between a collector and an emitter in a forward direction toward the collector from the emitter.

The first electric power conversion portion 12 is connected to an α-phase first coil 23 (α1) (third coil) and an α-phase second coil 24 (α2) (fourth coil) of the rotary electric machine 16 described later. The α-phase first coil 23 (α1) is connected between a first middle point and the second middle point in the first full-bridge circuit 12a. The first middle point of the first full-bridge circuit 12a is, for example, a connection point between a high-side arm element portion 21a (a1H) and a low-side arm element portion 21b (a1L) that are connected in series in the first phase of the first full-bridge circuit 12a. For example, the first middle point of the first full-bridge circuit 12a is a connection point between a source of the high-side arm element portion 21a (a1H) and a drain of the low-side arm element portion 21b (a1L).

The α-phase second coil 24 (α2) is connected between the third middle point and a fourth middle point in the second full-bridge circuit 12b. The fourth middle point of the second full-bridge circuit 12b is, for example, a connection point between a high-side arm element portion 21a (a4H) and a low-side arm element portion 21b (a4L) that are connected in series in the second phase of the second full-bridge circuit 12b. For example, the fourth middle point of the second full-bridge circuit 12b is a connection point between a source of the high-side arm element portion 21a (a4H) and a drain of the low-side arm element portion 21b (a4L).

The first electric power conversion portion 12 includes a first connection-disconnection device 25 that is connected between positive electrodes of the first full-bridge circuit 12a and the second full-bridge circuit 12b and a second connection-disconnection device 26 that is connected between negative electrodes of the first full-bridge circuit 12a and the second full-bridge circuit 12b. Each of the first connection-disconnection device 25 and the second connection-disconnection device 26 is, for example, a contactor and switches the connection between the first full-bridge circuit 12a and the second full-bridge circuit 12b between ON and OFF.

The first electric power conversion portion 12 includes, for example, a first capacitor (condenser) 27 that is connected between the positive electrode and the negative electrode. For example, the first capacitor 27 smooths voltage variation generated in accordance with a switching operation of each switching element of the first electric power conversion portion 12 between ON and OFF.

The first electric power conversion portion 12 includes a first current sensor 28a, a second current sensor 28b, and a third current sensor 28c. For example, the first current sensor 28a is arranged between the α-phase first coil 23 (α1) and the second middle point of the first full-bridge circuit 12a. The second current sensor 28b is arranged between the α-phase second coil 24 (α2) and the fourth middle point of the second full-bridge circuit 12b. The third current sensor 28c is arranged between the electric power storage device 11 and the first electric power conversion portion 12.

For example, the first current sensor 28a detects a current that flows through the α-phase first coil 23 (α1). The second current sensor 28b detects a current that flows through the α-phase second coil 24 (α2). The third current sensor 28c detects a current that flows between the first electric power conversion portion 12 and the electric power storage device 11.

The second electric power conversion portion 13 includes a third full-bridge circuit 13a and a fourth full-bridge circuit 13b. Each of the third full-bridge circuit 13a and the fourth full-bridge circuit 13b includes, for example, an H-bridge circuit formed of a plurality of switching elements connected in two phases by bridge connection. Each switching element included in the third full-bridge circuit 13a and the fourth full-bridge circuit 13b is, for example, a transistor of a SiC or the like, such as a MOSFET or an IGBT. Each switching element included in the third full-bridge circuit 13a and the fourth full-bridge circuit 13b is, for example, an N-channel type MOSFET.

The plurality of switching elements included in the third full-bridge circuit 13a and the fourth full-bridge circuit 13b are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 that is connected between a sixth middle point of the third full-bridge circuit 13a and a seventh middle point of the fourth full-bridge circuit 13b. The sixth middle point of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the sixth middle point of the third full-bridge circuit 13a is a connection point between a source of the high-side arm element portion 31a (b2H) and a drain of the low-side arm element portion 31b (b2L).

The seventh middle point of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the seventh middle point of the fourth full-bridge circuit 13b is a connection point between a source of the high-side arm element portion 31a (b3H) and a drain of the low-side arm element portion 31b (b3L).

The second switch 32 is, for example, a bidirectional switch formed of two switching elements. Each switching element included in the second switch 32 is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the sixth middle point of the third full-bridge circuit 13a and the seventh middle point of the fourth full-bridge circuit 13b by ON/OFF of the two transistors.

Each transistor included in the second switch 32 may include a rectifier element such as a reflux diode which is connected in parallel between a collector and an emitter in a forward direction toward the collector from the emitter.

The second electric power conversion portion 13 is connected to a β-phase first coil 33 (β1) (fifth coil) and a β-phase second coil 34 (β2) (sixth coil) of the rotary electric machine 16 described later. The β-phase first coil 33 is connected between a fifth middle point and the sixth middle point in the third full-bridge circuit 13a. The fifth middle point of the third full-bridge circuit 13a is, for example, a connection point between a high-side arm element portion 31a (b1H) and a low-side arm element portion 31b (b1L) that are connected in series in the first phase of the third full-bridge circuit 13a. For example, the fifth middle point of the third full-bridge circuit 13a is a connection point between a source of the high-side arm element portion 31a (b1H) and a drain of the low-side arm element portion 31b (b1L).

The β-phase second coil 34 (β2) is connected between the seventh middle point and an eighth middle point in the fourth full-bridge circuit 13b. The eighth middle point of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the eighth middle point of the fourth full-bridge circuit 13b is a connection point between a source of the high-side arm element portion 31a (b4H) and a drain of the low-side arm element portion 31b (b4L).

The second electric power conversion portion 13 includes a third connection-disconnection device 35 and a fourth connection-disconnection device 36. The third connection-disconnection device 35 is connected between the β-phase first coil 33 (β1) and the fifth middle point of the third full-bridge circuit 13a. The fourth connection-disconnection device 36 is connected between the β-phase second coil 34 (β2) and the eighth middle point of the fourth full-bridge circuit 13b. Each of the third connection-disconnection device 35 and the fourth connection-disconnection device 36 is, for example, a contactor. The third connection-disconnection device 35 switches the connection between the β-phase first coil 33 (β1) and the fifth middle point of the third full-bridge circuit 13a between ON and OFF. The fourth connection-disconnection device 36 switches the connection between the β-phase second coil 34 (β2) and the eighth middle point of the fourth full-bridge circuit 13b between ON and OFF.

The second electric power conversion portion 13 includes, for example, a second capacitor (condenser) 37 that is connected between the positive electrode and the negative electrode. For example, the second capacitor 37 smooths voltage variation generated in accordance with a switching operation of each switching element of the second electric power conversion portion 13 between ON and OFF.

The second electric power conversion portion 13 includes a fourth current sensor 38a and a fifth current sensor 38b. The fourth current sensor 38a is arranged between the β-phase first coil 33 (β1) and the sixth middle point of the third full-bridge circuit 13a. The fifth current sensor 38b is arranged between the β-phase second coil 34 (β2) and the eighth middle point of the fourth full-bridge circuit 13b. For example, the fourth current sensor 38a detects a current that flows through the β-phase first coil 33 (β1). The fifth current sensor 38b detects a current that flows through the β-phase second coil 34 (β2).

The DC charging terminal 14 and the AC charging terminal 15 include, for example, a connection device (connector) or the like for DC electric power and for AC electric power of a predetermined standard. The DC charging terminal 14 and the AC charging terminal 15 are connected, for example, to a DC electric power source (external DC electric power source) and an AC electric power source (external AC electric power source) at the outside on the basis of a commercial electric power source or the like that is connected to an electric power system.

The DC charging terminal 14 is connected to the negative electrode of the second electric power conversion portion 13 and to a middle point (that is, a point between the two transistors connected reversely in series) of each of the first switch 22 and the second switch 32. The AC charging terminal 15 is connected to the fifth middle point of the third full-bridge circuit 13a and to the eighth middle point of the fourth full-bridge circuit 13b. Further, the AC charging terminal 15 is connected to a connection point between the β-phase first coil 33 (β1) and the third connection-disconnection device 35 and is connected to a connection point between the β-phase second coil 34 (β2) and the fourth connection-disconnection device 36.

The rotary electric machine 16 is, for example, a two-phase AC brushless DC motor. As shown in FIG. 2, the rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42. The rotor 41 includes a field permanent magnet. Each coil α1, α2, β1, β2 that generates a rotating magnetic field which rotates the rotor 41 is attached to the stator core 42.

The α-phase first coil 23 (α1), the α-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the teeth of the stator core 42 in an identical direction when seen from an axis line direction along a center axis O of the rotary electric machine 16. The α-phase first coil 23 (α1) and the α-phase second coil 24 (α2) are arranged, for example, so as to share or respectively occupy part of a slot 43 formed in the stator core 42 and are magnetically coupled to each other in an identical polarity.

The β-phase first coil 33 (β1) and the β-phase second coil 34 (β2) set, for example, a spatial phase difference from each other to be zero and are wound with respect to the teeth of the stator core 42 in an identical direction when seen from the axis line direction along the center axis O of the rotary electric machine 16. The β-phase first coil 33 (β1) and the β-phase second coil 34 (β2) are arranged, for example, so as to share or respectively occupy part of the slot 43 formed in the stator core 42 and are magnetically coupled to each other in an identical polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°. For example, each coil α1, α2, β1, β2 is attached to the stator core 42 by concentrated winding, distributed winding, or the like.

For example, in the rotary electric machine 16, the β-phase first coil 33 (β1) and the β-phase second coil 34 (β2) are wound around a different slot 43 of an identical phase, and the α-phase first coil 23 (α1) and the α-phase second coil 24 (α2) are wound around an identical slot 43. Specifically, the β-phase first coil 33 (β1) is wound around a first slot SL1 and a second slot SL2, and the β-phase second coil 34 (β2) is wound around a third slot SL3 and a fourth slot SL4. The α-phase first coil 23 (α1) and the α-phase second coil 24 (α2) are wound around the first slot SL1 and the fourth slot SL4 and are also wound around the second slot SL2 and the third slot SL3.

The rotary electric machine 16 generates rotation power by performing a power running operation using electric power that is supplied from the first electric power conversion portion 12 and the second electric power conversion portion 13. For example, when the rotary electric machine 16 is connected to a wheel of a vehicle, the rotary electric machine 16 generates a travel drive force by the electric power that is supplied from the first electric power conversion portion 12 and the second electric power conversion portion 13. The rotary electric machine 16 may generate electric power by performing a regeneration operation using rotation power that is input from a wheel side of the vehicle. For example, when the rotary electric machine 16 is connected to an internal combustion engine of the vehicle, the rotary electric machine 16 may generate electric power using the power of the internal combustion engine.

The gate drive unit 17 switches each connection-disconnection device 25, 26, 35, 36 and each switching element of the first electric power conversion portion 12 and the second electric power conversion portion 13 between ON and OFF on the basis of a control signal received from the electronic control unit 18. For example, the gate drive unit 17 switches each switching element of each full-bridge circuit 12a, 12b, 13a, 13b between ON and OFF by outputting a gate signal generated by amplification, level shift, and the like of the control signal.

The position sensor 19 detects a rotation angle of the rotor 41 of the rotary electric machine 16 as a rotor angle θ and outputs an analog signal indicating a detection result of the rotor angle θ to the electronic control unit 18. For example, the position sensor 19 is a resolver that is attached to a rotor shaft (not shown) of the rotary electric machine 16.

The electronic control unit 18 integrally controls an operation of each of the electric power control unit 10a and the rotary electric machine 16. For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36 and each switching element of the first electric power conversion portion 12 and the second electric power conversion portion 13 are driven to ON and OFF. The electronic control unit 18 outputs the generated control signal to the gate drive unit 17.

### Control Operation of Electric Apparatus

The electronic control unit 18 sets the first connection-disconnection device 25 and the second connection-disconnection device 26 to an ON state in the case of the power running operation or the regeneration operation of the rotary electric machine 16. The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching of the first switch 22 and the second switch 32 between ON and OFF.

The electronic control unit 18 performs, for example, a feedback control or the like of a current in which a current detection value of the rotary electric machine 16 and a current target value in response to a torque command value of the rotary electric machine 16 are used and generates a control signal that commands the driving of each switching element of the first electric power conversion portion 12 and the second electric power conversion portion 13.

At the time of DC charging, that is, when the electric power storage device 11 is charged by the external DC electric power source that is connected to the DC charging terminal 14, the electronic control unit 18 sets the first connection-disconnection device 25 and the second connection-disconnection device 26 to an ON state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source that is connected to the AC charging terminal 15, the electronic control unit 18 sets the first connection-disconnection device 25 and the second connection-disconnection device 26 to an OFF state for insulation.

The electronic control unit 18 sets, for example, the α-phase first coil 23 (α1) and the α-phase second coil 24 (α2) that are magnetically coupled to each other in the identical polarity to be a coil of a DC conversion phase (α-phase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the identical polarity to be a coil of an AC input phase (β-phase) that is connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by a bridge connection. The totem pole PFC is a PFC that includes a pair of switching elements of an identical conductivity type which are connected (totem pole connection) in series in an identical direction. The electronic control unit 18 performs the power factor correction of an input voltage Vac and an input current Iac while performing rectification of AC electric power that is received from the external AC electric power source into DC electric power and increasing the voltage, for example, by controlling the switching of each switching element in each full-bridge circuit 13a, 13b of the second electric power conversion portion 13.

An operation of the electronic control unit 18 at the time of DC charging is described in detail below.

At the time of DC charging, the electronic control unit 18 performs a pulse width modulation on the basis of a duty command value and a first carrier wave CW1 and thereby generates a control signal indicating a timing of driving each element portion a1H, a1L, a2H, a2L, a3H, a3L, a4H, a4L included in the first electric power conversion portion 12 to be ON and OFF.

Further, at the time of DC charging, the electronic control unit 18 performs a pulse width modulation on the basis of a duty command value and a second carrier wave CW2 and thereby generates a control signal indicating a timing of driving each of element portion b1H, b1L, b2H, b2L, b3H, b3L, b4H, b4L included in the second electric power conversion portion 13 to be ON and OFF. For example, the first carrier wave CW1 and the second carrier wave CW2 are a triangle wave.

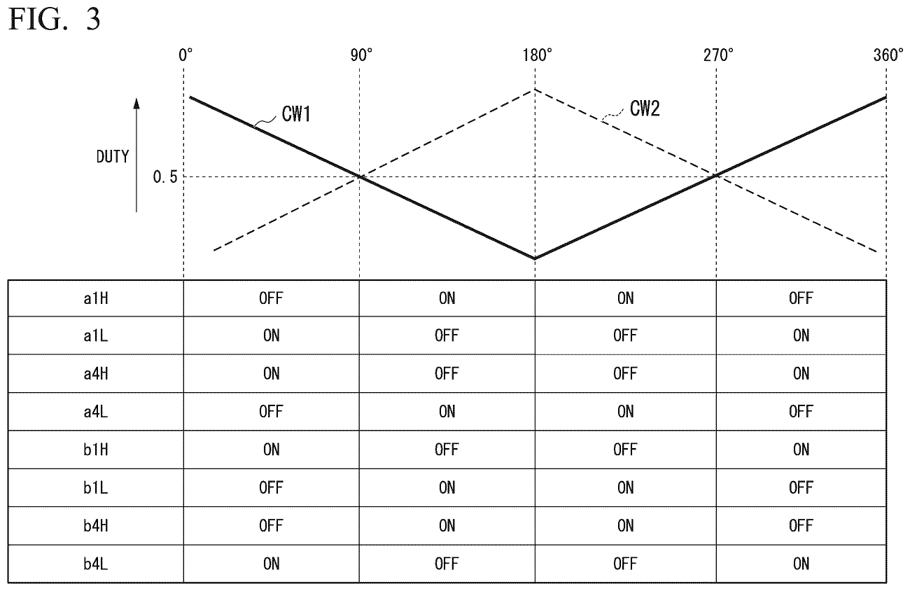

FIG. 3 is a view showing changes of states of the first carrier wave CW1, the second carrier wave CW2, and each element portion at the time of DC charging. FIG. 3 shows an example of the case where the duty command value is 0.5. Further, FIG. 3 shows an example of the case where a phase difference between the first carrier wave CW1 and the second carrier wave CW2 is 180 degrees in an electric angle. In the following description, the phase difference between the first carrier wave CW1 and the second carrier wave CW2 may be referred to as a carrier phase difference.

At the time of DC charging, the electronic control unit 18 compares the magnitude of the duty command value and the first carrier wave CW1, and when the duty command value is less than a value of the first carrier wave CW1, the electronic control unit 18 sets the element portions a1H, a4L to an ON state and sets the element portions a1L, a4H to an OFF state. Further, at the time of DC charging, when the duty command value is equal to or more than a value of the first carrier wave CW1, the electronic control unit 18 sets the element portions a1H, a4L to an OFF state and sets the element portions a1L, a4H to an ON state.

At the time of DC charging, the electronic control unit 18 compares the magnitude of the duty command value and the second carrier wave CW2, and when the duty command value is less than a value of the second carrier wave CW2, the electronic control unit 18 sets the element portions b1H, b4L to an ON state and sets the element portions b1L, b4H to an OFF state. Further, at the time of DC charging, when the duty command value is equal to or more than a value of the second carrier wave CW2, the electronic control unit 18 sets the element portions b1H, b4L to an OFF state and sets the element portions b1L, b4H to an ON state.

Although not shown in FIG. 3, at the time of DC charging, the electronic control unit 18 sets all of the element portions a2H, a2L, a3H, a3L included in the first electric power conversion portion 12 to an OFF state regardless of the duty command value. Further, at the time of DC charging, the electronic control unit 18 sets all of the element portions b2H, b2L, b3H, b3L included in the second electric power conversion portion 13 to an OFF state regardless of the duty command value.

In a period from 0 degree to 90 degrees and a period from 270 degrees to 360 degrees, a charging current that flows into the first switch 22 from the positive electrode of the DC charging terminal 14 is separated into a current that passes through the α-phase first coil 23 (α1) and the element portion a1L and returns to the negative electrode of the DC charging terminal 14 and a current that passes through the α-phase second coil 24 (α2), the element portion a4H, and the electric power storage device 11 and returns to the negative electrode of the DC charging terminal 14. That is, in the period from 0 degree to 90 degrees and the period from 270 degrees to 360 degrees, magnetic energy is accumulated in the α-phase first coil 23 (α1), and magnetic energy is discharged as electric energy (current) from the α-phase second coil 24 (α2).

In the period from 0 degree to 90 degrees and the period from 270 degrees to 360 degrees, a charging current that flows into the second switch 32 from the positive electrode of the DC charging terminal 14 is separated into a current that passes through the β-phase first coil 33 (β1), the element portion b1H, and the electric power storage device 11 and returns to the negative electrode of the DC charging terminal 14 and a current that passes through the β-phase second coil 34 (β2) and the element portion b4L and returns to the negative electrode of the DC charging terminal 14. That is, in the period from 0 degree to 90 degrees and the period from 270 degrees to 360 degrees, magnetic energy is accumulated in the β-phase second coil 34 (β2), and magnetic energy is discharged as electric energy (current) from the β-phase first coil 33 (β1).

In a period from 90 degrees to 180 degrees and a period from 180 degrees to 270 degrees, a charging current that flows into the first switch 22 from the positive electrode of the DC charging terminal 14 is separated into a current that passes through the α-phase first coil 23 (α1), the element portion a1H, and the electric power storage device 11 and returns to the negative electrode of the DC charging terminal 14 and a current that passes through the α-phase second coil 24 (α2) and the element portion a4L and returns to the negative electrode of the DC charging terminal 14. That is, in the period from 90 degrees to 180 degrees and the period from 180 degrees to 270 degrees, magnetic energy is accumulated in the α-phase second coil 24 (α2), and magnetic energy is discharged as electric energy (current) from the α-phase first coil 23 (α1).

In the period from 90 degrees to 180 degrees and the period from 180 degrees to 270 degrees, a charging current that flows into the second switch 32 from the positive electrode of the DC charging terminal 14 is separated into a current that passes through the β-phase first coil 33 (β1) and the element portion b1L and returns to the negative electrode of the DC charging terminal 14 and a current that passes through the β-phase second coil 34 (β2), the element portion b4H, and the electric power storage device 11 and returns to the negative electrode of the DC charging terminal 14. That is, in the period from 90 degrees to 180 degrees and the period from 180 degrees to 270 degrees, magnetic energy is accumulated in the β-phase first coil 33 (β1), and magnetic energy is discharged as electric energy (current) from the β-phase second coil 34 (β2).

As described above, at the time of DC charging, each of the first electric power conversion portion 12 and the second electric power conversion portion 13 operates as an interleaved boost converter. As known well, the interleave boost converter is a converter constituted of two boost converters that operate at a phase opposite to each other by 180 degrees. In the following description, the first electric power conversion portion 12 and the second electric power conversion portion 13 operating as the interleaved boost converter may be referred to as an “interleaved operation”.

In the present embodiment, at the time of DC charging, the first electric power conversion portion 12 and the second electric power conversion portion 13 perform the interleaved operation at a phase opposite to each other by 180 degrees. In other words, at the time of DC charging, the electronic control unit 18 controls each element portion included in the first electric power conversion portion 12 and the second electric power conversion portion 13 on the basis of the duty command value, the first carrier wave CW1, and the second carrier wave CW2 such that the first electric power conversion portion 12 and the second electric power conversion portion 13 perform the interleaved operation at the opposite phase. In this way, at the time of DC charging, the first electric power conversion portion 12 and the second electric power conversion portion 13 perform the interleaved operation at the opposite phase, and thereby, the magnetic fluxes of the phases are mutually cancelled. As a result, an iron loss is reduced, and the charging efficiency is improved.

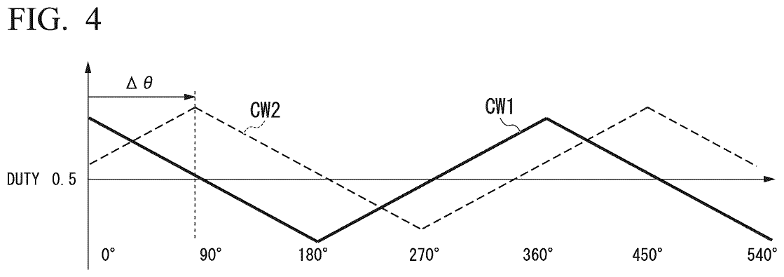

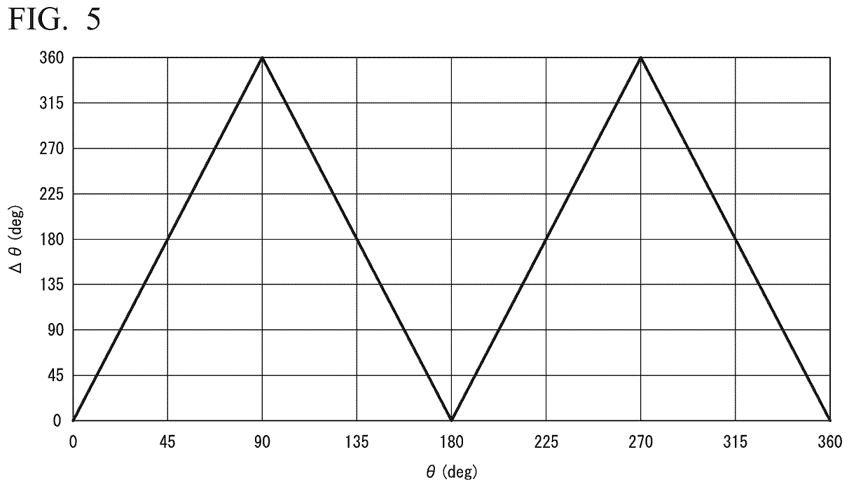

FIG. 4 is a view showing a first carrier wave CW1 and a second carrier wave CW2 having an arbitrary carrier phase difference Δθ relative to the first carrier wave CW1. FIG. 5 is a view showing a correspondence relationship between a rotor angle θ and the carrier phase difference Δθ. Each of the rotor angle θ and the carrier phase difference Δθ is an electric angle. As shown in FIG. 5, the carrier phase difference Δθ at which an iron loss is minimized is determined in accordance with the rotor angle θ. Therefore, in the present embodiment, the electronic control unit 18 sets the carrier phase difference Δθ between the first carrier wave CW1 and the second carrier wave CW2 on the basis of the rotor angle θ obtained from an output signal of the position sensor 19 at the time of DC charging.

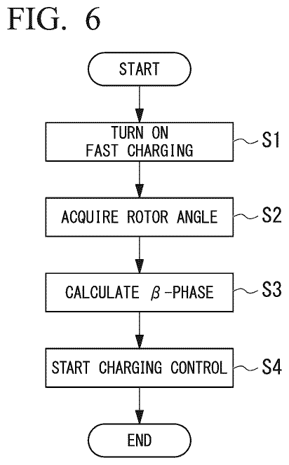

Based on the above descriptions, a DC charging process performed by the electronic control unit 18 is described below with reference to FIG. 6. FIG. 6 is a flowchart showing the DC charging process performed by the electronic control unit 18.

As shown in FIG. 6, when the DC charging process is started, first, the electronic control unit 18 turns on a fast charging (Step S1) and acquires a rotor angle θ based on an output signal of the position sensor 19 (Step S2).

The electronic control unit 18 calculates a carrier phase difference Δθ (β-phase) based on the acquired rotor angle θ (Step S3). For example, table data indicating the correspondence relationship between the rotor angle θ and the carrier phase difference Δθ as shown in FIG. 5 is stored in an internal memory of the electronic control unit 18. In Step S3, the electronic control unit 18 acquires the carrier phase difference Δθ corresponding to the acquired rotor angle θ from the table data described above.

The electronic control unit 18 starts a charging control based on the acquired carrier phase difference Δθ and the duty command value (Step S4). Specifically, the electronic control unit 18 sets the phase difference between the first carrier wave CW1 and the second carrier wave CW2 to the acquired carrier phase difference Δθ. Then, the electronic control unit 18 controls the first electric power conversion portion 12 based on the duty command value and the first carrier wave CW1 and controls the second electric power conversion portion 13 based on the duty command value and the second carrier wave CW2.

As described above, in the electric apparatus 10 of the present embodiment, at the time of DC charging, the electronic control unit 18 controls the first electric power conversion portion 12 based on the duty command value and the first carrier wave CW1 and controls the second electric power conversion portion 13 based on the duty command value and the second carrier wave CW2.

Further, at the time of DC charging, the electronic control unit 18 sets the phase difference between the first carrier wave CW1 and the second carrier wave CW2 based on the rotor angle θ obtained from the output signal of the position sensor 19. In this way, at the time of DC charging, by setting the phase difference between the first carrier wave CW1 and the second carrier wave CW2 based on the rotor angle θ, it is possible to prevent a magnetic flux density of each phase from being increased. As a result, an iron loss is reduced, and the charging efficiency is improved.

Further, in the present embodiment, the α-phase coil is constituted by connecting the α-phase first coil 23 (α1) and the α-phase second coil 24 (α2) in series in a state where the α-phase first coil 23 (α1) and the α-phase second coil 24 (α2) are coupled in and identical direction, the β-phase coil is constituted by connecting the β-phase first coil 33 (β1) and the β-phase second coil 34 (β2) in series in a state where the β-phase first coil 33 (β1) and the β-phase second coil 34 (β2) are coupled in an identical direction, the positive electrode of the DC charging terminal 14 is connected to each of a connection point between the α-phase first coil 23 (α1) and the α-phase second coil 24 (α2) and a connection point between the β-phase first coil 33 (β1) and the β-phase second coil 34 (β2), and the negative electrode of the DC charging terminal 14 is connected to the negative electrode of the electric power storage device 11. Thereby, since an iron loss is reduced by a current flowing in a direction in which each of the α-phase coil and the β-phase coil cancels a magnetic flux, the charging efficiency is improved, and it is possible to prevent a charging torque from being generated.

Further, in the present embodiment, at the time of DC charging, the electronic control unit 18 controls the first electric power conversion portion 12 and the second electric power conversion portion 13 such that each of the first electric power conversion portion 12 and the second electric power conversion portion 13 operates as an interleaved boost converter. Thereby, since the ripple of the current that flows through each coil is reduced, the effect of reducing the iron loss and the effect of improving the charging efficiency are further enhanced.

Further, in the present embodiment, the α-phase coil is constituted of the α-phase first coil 23 (α1) and the α-phase second coil 24 (α2) in which a middle point of the α-phase coil is a boundary, and the α-phase first coil 23 (α1) and the α-phase second coil 24 (α2) are wound around an identical slot in the rotary electric machine 16. In this way, by employing a structure in which the α-phase first coil 23 (α1) and the α-phase second coil 24 (α2) are wound around the identical slot in the rotary electric machine 16, a magnetic coupling degree between the α-phase first coil 23 (α1) and the α-phase second coil 24 (α2) can be enhanced, and therefore, it is possible to improve the charging efficiency.

Further, in the present embodiment, the β-phase coil is constituted of the β-phase first coil 33 (β1) and the β-phase second coil 34 (β2) in which a middle point of the β-phase coil as a boundary, the β-phase first coil 33 (β1) and the β-phase second coil 34 (β2) are wound around a different slot of an identical phase in the rotary electric machine 16, and when controlling the first full-bridge circuit and the second full-bridge circuit such that electric power is supplied to the β-phase coil among the α-phase coil and the β-phase coil at the time of DC charging, the electronic control unit 18 controls the first full-bridge circuit and the second full-bridge circuit such that a current flows in a direction in which a magnetic field is cancelled with respect to the rotor 41. Thereby, it is possible to prevent a charging torque from being generated at the rotary electric machine 16 while structurally ensuring the inductance of the rotary electric machine 16.

Although an embodiment of the present invention has been described, the present invention is not limited to the embodiment described above, and various modifications and substitutions can be made without departing from the scope of the present invention.

### First Modification Example

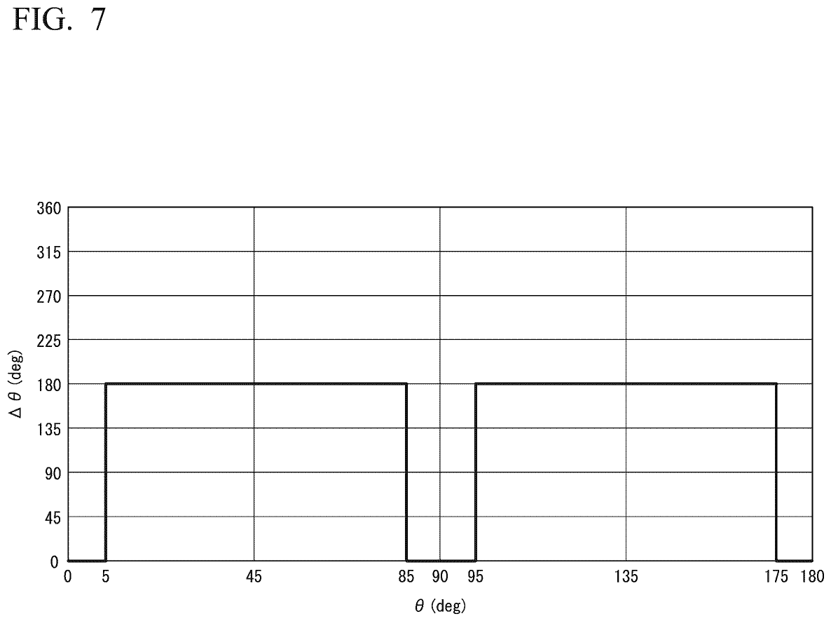

FIG. 7 is a view showing a modification example of a correspondence relationship between the rotor angle θ and the carrier phase difference Δθ.

For example, the above embodiment is described using an example in which the carrier phase difference Δθ is linearly changed in accordance with the rotor angle θ (refer to FIG. 5). However, as shown in FIG. 7, depending on the characteristics of the rotary electric machine 16, there may be cases in which by setting the carrier phase difference Δθ to 0 degree only at a rotor angle θ corresponding to the vicinity of a position that faces a magnetic center of the α-phase or the β-phase such as the rotor angles θ of 0 degree and 90 degrees and setting the carrier phase difference Δθ to 180 degrees at other rotor angles θ, the iron loss is further reduced, and the charging efficiency is improved.

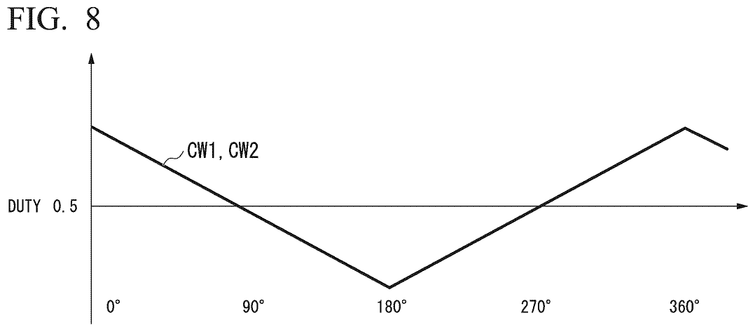

Therefore, the electronic control unit 18 may set the carrier phase difference Δθ to 0 degree when the rotor angle θ is 0 degrees, 90 degrees, or the like and may set the carrier phase difference Δθ to 180 degrees at other rotor angles θ instead of the linear change of the carrier phase difference Δθ in accordance with the rotor angle θ. FIG. 8 is a view showing the case where the carrier phase difference Δθ between the first carrier wave CW1 and the second carrier wave CW2 is 0 degrees. As shown in FIG. 8, when the carrier phase difference Δθ is 0 degrees, the second carrier wave CW2 is matched with the first carrier wave CW1.

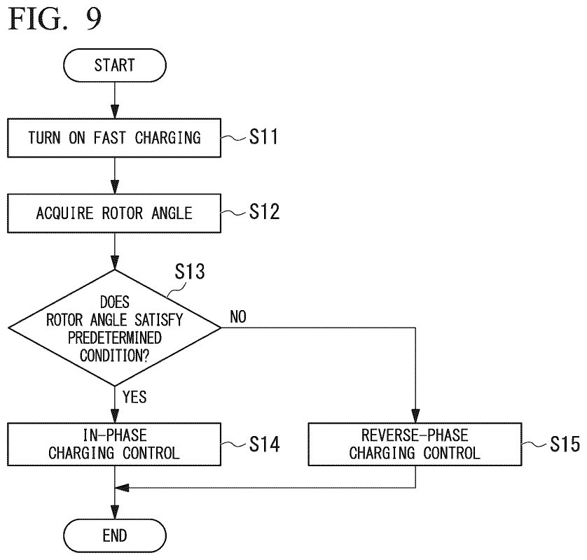

FIG. 9 is a flowchart showing a modification example of a DC charging process performed by the electronic control unit 18. As shown in FIG. 9, when the DC charging process is started, first, the electronic control unit 18 turns on a fast charging (Step S11) and acquires a rotor angle θ based on an output signal of the position sensor 19 (Step S12).

The electronic control unit 18 determines whether or not the acquired rotor angle θ satisfies a predetermined condition (Step S13). Specifically, in Step S13, the electronic control unit 18 determines whether or not the acquired rotor angle θ (unit:
degree) satisfies the following condition expression (1). In the following condition expression (1), n is an integer of 1 or more.

θ=90×(n−1)±5 (1)

When the acquired rotor angle θ satisfies the condition expression (1) (Step S13:
YES), the electronic control unit 18 sets the carrier phase difference Δθ to 0 degree and performs an in-phase charging control (Step S14). On the other hand, when the acquired rotor angle θ does not satisfy the condition expression (1) (Step S13: NO), the electronic control unit 18 sets the carrier phase difference Δθ to 180 degrees and performs a reverse-phase charging control (Step S15).

The in-phase charging control means that the first electric power conversion portion 12 and the second electric power conversion portion 13 are controlled such that the first electric power conversion portion 12 and the second electric power conversion portion 13 perform the interleaved operation in the same phase. Further, the reverse-phase charging control means that the first electric power conversion portion 12 and the second electric power conversion portion 13 are controlled such that the first electric power conversion portion 12 and the second electric power conversion portion 13 perform the interleaved operation in the reverse phase.

### Second Modification Example

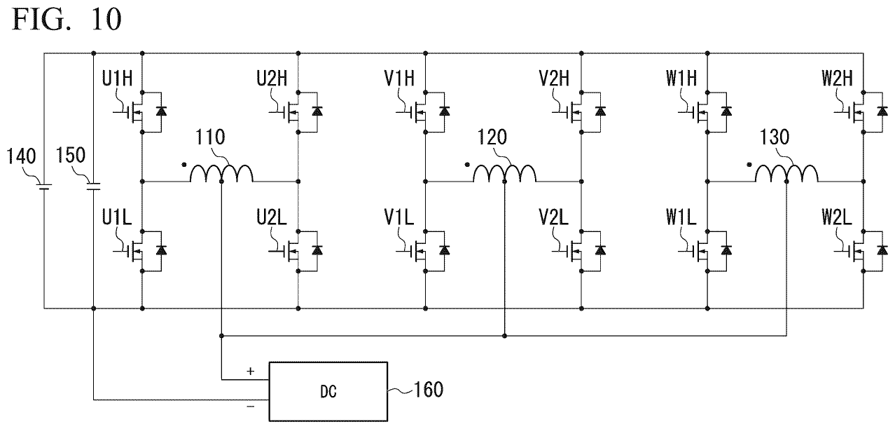

The above embodiment is described using an example in which the electric apparatus 10 includes the rotary electric machine 16 which is a two-phase motor; however, the electric apparatus 10 may include a three-phase motor of an open winding type as the rotary electric machine. FIG. 10 is a view showing an example of a DC charging circuit included in an electric apparatus 10 including a three-phase motor as the rotary electric machine. As shown in FIG. 10, the three-phase motor includes a U-phase coil 110, a V-phase coil 120, and a W-phase coil 130.

The electric apparatus 10 in the second modification example includes a first U-phase high-side switch U1H, a second U-phase high-side switch U2H, a first U-phase low-side switch U1L, and a second U-phase low-side switch U2L. These switches are, for example, a N-channel MOSFET.

A drain terminal of each of the first U-phase high-side switch U1H and the second U-phase high-side switch U2H is connected to a positive electrode of an electric power storage device 140. A source terminal of the first U-phase high-side switch U1H is connected to one end of the U-phase coil 110. A source terminal of the second U-phase high-side switch U2H is connected to the other end of the U-phase coil 110.

A source terminal of each of the first U-phase low-side switch U1L and the second U-phase low-side switch U2L is connected to a negative electrode of the electric power storage device 140. A drain terminal of the first U-phase low-side switch U1L is connected to one end of the U-phase coil 110. A drain terminal of the second U-phase low-side switch U2L is connected to the other end of the U-phase coil 110.

As described above, a U-phase full-bridge circuit connected to both ends of the U-phase coil 110 is constituted of the first U-phase high-side switch U1H, the second U-phase high-side switch U2H, the first U-phase low-side switch U1L, and the second U-phase low-side switch U2L. The U-phase full-bridge circuit is an H-bridge circuit.

The electric apparatus 10 in the second modification example includes a first V-phase high-side switch V1H, a second V-phase high-side switch V2H, a first V-phase low-side switch V1L, and a second V-phase low-side switch V2L. These switches are, for example, a N-channel MOSFET.

A drain terminal of each of the first V-phase high-side switch V1H and the second V-phase high-side switch V2H is connected to the positive electrode of the electric power storage device 140. A source terminal of the first V-phase high-side switch V1H is connected to one end of the V-phase coil 120. A source terminal of the second V-phase high-side switch V2H is connected to the other end of the V-phase coil 120.

A source terminal of each of the first V-phase low-side switch V1L and the second V-phase low-side switch V2L is connected to the negative electrode of the electric power storage device 140. A drain terminal of the first V-phase low-side switch V1L is connected to one end of the V-phase coil 120. A drain terminal of the second V-phase low-side switch V2L is connected to the other end of the V-phase coil 120.

As described above, a V-phase full-bridge circuit connected to both ends of the V-phase coil 120 is constituted of the first V-phase high-side switch V1H, the second V-phase high-side switch V2H, the first V-phase low-side switch V1L, and the second V-phase low-side switch V2L. The V-phase full-bridge circuit is an H-bridge circuit.

The electric apparatus 10 in the second modification example includes a first W-phase high-side switch W1H, a second W-phase high-side switch W2H, a first W-phase low-side switch W1L, and a second W-phase low-side switch W2L. These switches are, for example, a N-channel MOSFET.

A drain terminal of each of the first W-phase high-side switch W1H and the second W-phase high-side switch W2H is connected to the positive electrode of the electric power storage device 140. A source terminal of the first W-phase high-side switch W1H is connected to one end of the W-phase coil 130. A source terminal of the second W-phase high-side switch W2H is connected to the other end of the W-phase coil 130.

A source terminal of each of the first W-phase low-side switch W1L and the second W-phase low-side switch W2L is connected to the negative electrode of the electric power storage device 140. A drain terminal of the first W-phase low-side switch W1L is connected to one end of the W-phase coil 130. A drain terminal of the second W-phase low-side switch W2L is connected to the other end of the W-phase coil 130.

As described above, a W-phase full-bridge circuit connected to both ends of the W-phase coil 130 is constituted of the first W-phase high-side switch W1H, the second W-phase high-side switch W2H, the first W-phase low-side switch W1L, and the second W-phase low-side switch W2L. The W-phase full-bridge circuit is an H-bridge circuit.

A positive electrode of a DC charging terminal 160 is connected to each of a middle point of the U-phase coil 110, a middle point of the V-phase coil 120, and a middle point of the W-phase coil 130. A negative electrode of the DC charging terminal 160 is connected to the negative electrode of the electric power storage device 140. A smoothing capacitor 150 is connected in parallel to the electric power storage device 140.

Although not shown in FIG. 10, the electric apparatus 10 in the second modification example also includes a gate drive unit 17, an electronic control unit 18, a position sensor 19, and the like. The position sensor 19 in the second modification example detects a rotation angle of the rotor of the three-phase motor as a rotor angle θ and outputs an analog signal indicating a detection result of the rotor angle θ to the electronic control unit 18.

At the time of DC charging, the electronic control unit 18 performs a pulse width modulation based on a duty command value and a U-phase carrier wave CWU and thereby generates a control signal indicating a timing when each switch included in the U-phase full-bridge circuit is driven to ON and OFF.

Further, at the time of DC charging, the electronic control unit 18 performs a pulse width modulation based on a duty command value and a V-phase carrier wave CWV and thereby generates a control signal indicating a timing when each switch included in the V-phase full-bridge circuit is driven to ON and OFF.

Further, at the time of DC charging, the electronic control unit 18 performs a pulse width modulation based on a duty command value and a W-phase carrier wave CWW and thereby generates a control signal indicating a timing when each switch included in the W-phase full-bridge circuit is driven to ON and OFF. For example, each of the U-phase carrier wave CWU, the V-phase carrier wave CWV, and the W-phase carrier wave CWW is a triangle wave.

The electronic control unit 18 sets a phase difference among the three carrier waves described above based on the rotor angle θ obtained from an output signal of the position sensor 19.

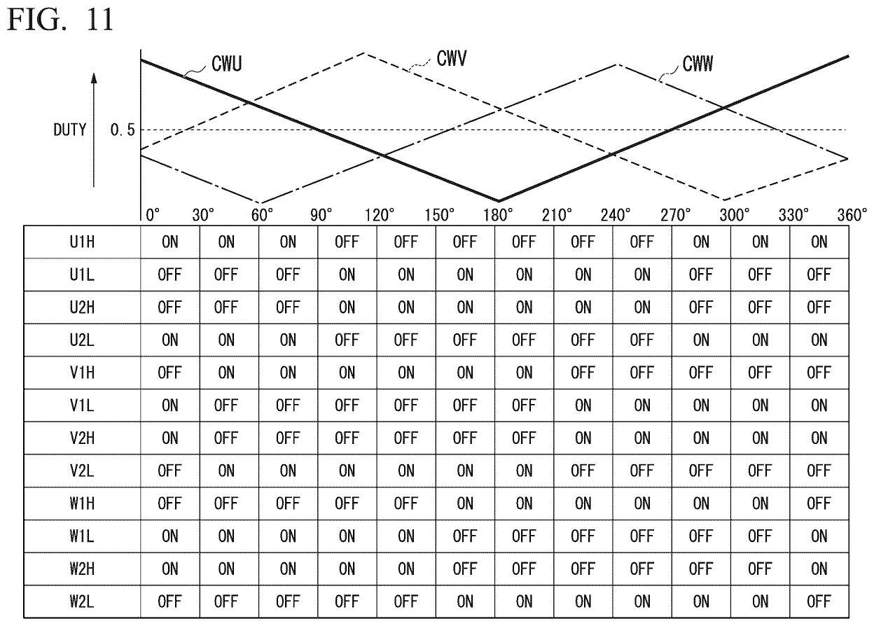

FIG. 11 is a view showing changes in states of the three carrier waves and each switch in the case where the electric apparatus 10 includes the three-phase motor. FIG. 11 shows the case where the duty command value is 0.5 as an example. Further, FIG. 11 shows the case where the phase difference among the three carrier waves described above is 120 degrees in an electric angle as an example.

At the time of DC charging, the electronic control unit 18 compares the magnitude of a duty command value and the U-phase carrier wave CWU, and when the duty command value is less than a value of the U-phase carrier wave CWU, the electronic control unit 18 sets the first U-phase high-side switch U1H and the second U-phase low-side switch U2L to an OFF state and sets the first U-phase low-side switch U1L and the second U-phase high-side switch U2H to an ON state. Further, at the time of DC charging, when the duty command value is equal to or more than the value of the U-phase carrier wave CWU, the electronic control unit 18 sets the first U-phase high-side switch U1H and the second U-phase low-side switch U2L to an ON state and sets the first U-phase low-side switch U1L and the second U-phase high-side switch U2H to an OFF state.

At the time of DC charging, the electronic control unit 18 compares the magnitude of a duty command value and the V-phase carrier wave CWV, and when the duty command value is less than a value of the V-phase carrier wave CWV, the electronic control unit 18 sets the first V-phase high-side switch V1H and the second V-phase low-side switch V2L to an OFF state and sets the first V-phase low-side switch V1L and the second V-phase high-side switch V2H to an ON state. Further, at the time of DC charging, when the duty command value is equal to or more than the value of the V-phase carrier wave CWV, the electronic control unit 18 sets the first V-phase high-side switch V1H and the second V-phase low-side switch V2L to an ON state and sets the first V-phase low-side switch V1L and the second V-phase high-side switch V2H to an OFF state.

At the time of DC charging, the electronic control unit 18 compares the magnitude of the duty command value and the W-phase carrier wave CWW, and when the duty command value is less than a value of the W-phase carrier wave CWW, the electronic control unit 18 sets the first W-phase high-side switch W1H and the second W-phase low-side switch W2L to an OFF state and sets the first W-phase low-side switch W1L and the second W-phase high-side switch W2H to an ON state. Further, at the time of DC charging, when the duty command value is equal to or more than the value of the W-phase carrier wave CWW, the electronic control unit 18 sets the first W-phase high-side switch W1H and the second W-phase low-side switch W2L to an ON state and sets the first W-phase low-side switch W1L and the second W-phase high-side switch W2H to an OFF state.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine;
an electric power control unit that is connected to the electric power storage device and the rotary electric machine and controls electric power transfer of each of the electric power storage device and the rotary electric machine;
a DC charging terminal that connects the electric power control unit to an external DC electric power source; and
a position sensor that detects a rotation angle of a rotor of the rotary electric machine as a rotor angle,
wherein the rotary electric machine comprises a first coil and a second coil that have a phase which is orthogonal to each other,
the electric power control unit comprises
a first full-bridge circuit connected to both ends of the first coil,
a second full-bridge circuit connected to both ends of the second coil, and
a control device that controls the first full-bridge circuit based on a duty command value and a first carrier wave and controls the second full-bridge circuit based on the duty command value and a second carrier wave, and
the control device sets a phase difference between the first carrier wave and the second carrier wave based on the rotor angle obtained from an output signal of the position sensor at a time of DC charging in which the electric power storage device is charged by electric power supplied from the external DC electric power source.

2. The electric apparatus according to claim 1,
wherein the first coil is constituted by connecting a third coil and a fourth coil in series in a state where the third coil and the fourth coil are coupled in an identical direction,
the second coil is constituted by connecting a fifth coil and a sixth coil in series in a state where the fifth coil and the sixth coil are coupled in an identical direction,
a positive electrode of the DC charging terminal is connected to each of a connection point between the third coil and the fourth coil and a connection point between the fifth coil and the sixth coil, and
a negative electrode of the DC charging terminal is connected to a negative electrode of the electric power storage device.

3. The electric apparatus according to claim 2,
wherein at the time of DC charging, the control device controls the first full-bridge circuit and the second full-bridge circuit such that each of the first full-bridge circuit and the second full-bridge circuit operates as an interleaved boost converter.

4. The electric apparatus according to claim 1,
wherein the first coil is constituted of the third coil and the fourth coil in which a middle point of the first coil is a boundary, and
the third coil and the fourth coil are wound around an identical slot in the rotary electric machine.

5. The electric apparatus according to claim 4,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.

6. The electric apparatus according to claim 2,
wherein the first coil is constituted of the third coil and the fourth coil in which a middle point of the first coil is a boundary, and
the third coil and the fourth coil are wound around an identical slot in the rotary electric machine.

7. The electric apparatus according to claim 6,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.

8. The electric apparatus according to claim 3,
wherein the first coil is constituted of the third coil and the fourth coil in which a middle point of the first coil is a boundary, and
the third coil and the fourth coil are wound around an identical slot in the rotary electric machine.

9. The electric apparatus according to claim 8,
wherein the second coil is constituted of the fifth coil and the sixth coil in which a middle point of the second coil is a boundary,
the fifth coil and the sixth coil are wound around a different slot of an identical phase in the rotary electric machine, and
when controlling the first full-bridge circuit and the second full-bridge circuit such that electric power is supplied to the second coil among the first coil and the second coil at the time of DC charging, the control device controls the first full-bridge circuit and the second full-bridge circuit such that a current flows in a direction in which a magnetic field is cancelled with respect to the rotor.
